(19) United States
(12) Patent Application Publication
(10) Pub. No.: US 2026/0288725 A1
(43) Pub. Date: Sep. 24, 2026

(54) OPTIMIZED SCALAR QUANTIZATION

(71) Applicant: Elastic Technologies (US) Inc., Wilmington, DE (US)

(72) Inventors: Benjamin Whitefield Trent, Greer, SC (US); Thomas James Veasey, York (GB); John Wagster, Franklin, TN (US)

(21) Appl. No.: 19/575,352

(22) Filed: Mar. 23, 2026

Related U.S. Application Data
(60) Provisional application No. 63/775,590, filed on Mar. 21, 2025.

(51) Int. Cl. G06F 16/2453; G06F 16/22

(52) U.S. Cl. CPC G06F 16/24542; G06F 16/2237; G06F 16/2264

(57) ABSTRACT

According to at least one implementation, a method includes receiving a set of vectors from a dataset, where each vector in the set comprises a plurality of dimensions. For a given vector in the set, the method includes determining at least one scaling factor for the plurality of dimensions, iteratively adjusting this scaling factor based on a quantization error to generate at least one optimally adjusted scaling factor, and determining a compressed, quantized vector based on the adjusted scaling factor.

### CROSS-REFERENCE TO RELATED APPLICATION

This application claims the benefit of U.S. Provisional Application No. 63/775,590, filed March 21, 2025, the disclosure of which is incorporated herein by reference in its entirety.

### BACKGROUND

Machine learning models are frequently used to generate high-dimensional vectors that capture the important information and underlying concepts of the data they represent. By converting files, such as text documents, into these vectors, systems can perform advanced vector search tasks to retrieve specific subsets of information in response to a user query. For example, instead of relying on exact word matching, converting files to vectors enables semantic retrieval, which allows a system to retrieve documents based on how well their concepts match a user’s question.

Once created, these vectors are typically stored in specialized data stores called vector databases, which enable efficient, fast querying. When a user submits a query, the database converts it into a vector and performs a nearest-neighbor search to retrieve the stored vectors that most closely match the query vector. This robust retrieval process underpins many modern applications, including cross-modal image search (where a text query retrieves matching images) and recommendation systems that suggest products based on past behavior.

### SUMMARY

Described herein are systems and methods for performing optimized scalar quantization to compress high-dimensional data vectors, reducing memory requirements and improving query latency in vector databases. In some implementations, a system receives a set of vectors from a dataset, where each vector comprises a plurality of dimensions. To group the data more tightly together for efficient compression, the system can first translate the set of vectors by subtracting a global centroid of the dataset from each vector. Then, for each individual vector, the system can determine at least one scaling factor for the vector dimensions. Determining the scaling factor can include an initialization step that computes the initial boundary endpoints based on the statistical mean and standard deviation of the data, along with constants determined by the available number of bits for quantization. Once initialized, the system can use an iterative mathematical procedure to adjust these boundaries by adjusting the scaling factor based on a calculated quantization error, generating an optimally adjusted scaling factor tailored to that specific vector. Finally, the system determines a discrete quantized vector based on this uniquely adjusted scaling factor, effectively converting memory-intensive floating-point numbers into compact integer representations.

To achieve even greater compression accuracy, the system can partition a vector into smaller subsets before quantization. The system can separate a vector into at least a first channel and a second channel, optionally rearranging the dimensions to group correlated components together, and compute uniquely adjusted scaling factors for each channel. To ensure that the original mathematical relationships between vectors can be accurately recovered during a search, the system can calculate and store specific metadata alongside the quantized vectors. This includes storing an additional value comprising the dot product of the subtracted centroid and the original vector, as well as a cached sum of the quantized vector’s components. When a user submits a query, the system converts the query into a similarly quantized query vector and performs fast, hardware-accelerated integer dot products. By combining fast integer comparisons with stored metadata values and scalar additions, the system can rapidly and accurately reconstruct maximum inner-product similarity scores, thereby retrieving the closest matching documents with high recall.

In some aspects, the techniques described herein relate to a method including: receiving a set of vectors from a dataset, wherein each vector in the set of vectors includes a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

In some aspects, the techniques described herein relate to a computer-readable storage medium having program instructions stored thereon that, when executed by at least one processor, direct the at least one processor to perform a method, the method including: receiving a set of vectors from a dataset, wherein each vector in the set of vectors includes a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

In some aspects, the techniques described herein relate to a computing system including: at least one processor; a computer-readable storage medium operatively coupled to the at least one processor; and program instructions stored on the computer-readable storage medium that, when executed by the at least one processor, direct the computing system to perform a method, the method including: receiving a set of vectors from a dataset, wherein each vector in the set of vectors includes a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

The accompanying drawings and the description below outline the details of one or more implementations. Other features will be apparent from the description, drawings, and claims.

### BRIEF DESCRIPTION OF THE DRAWINGS

FIG. 1 illustrates an operational scenario of providing scalar quantization according to an implementation.

FIG. 2 illustrates a method of providing scalar quantization according to an implementation.

FIG. 3 illustrates an operational scenario of separating a vector into channels according to an implementation.

FIG. 4 illustrates an operational scenario of performing a search according to an implementation.

FIG. 5 illustrates an operational scenario of performing iterative quantization improvement according to an implementation.

FIG. 6 illustrates a computing system provide scalar quantization according to an implementation.

### DETAILED DESCRIPTION

Machine learning models often convert complex data, such as text documents or images, into high-dimensional vectors so that systems can perform advanced searches, like retrieving documents based on matching concepts rather than exact words. However, storing and searching through massive databases of these vectors requires significant memory and computing power. To reduce these memory requirements and speed up searches, systems can use quantization to compress these floating-point vectors into smaller, discrete integer values. At least one technical problem with traditional scalar quantization is that the process applies the same compression intervals globally to every vector. This rigid approach fails to account for variations in the data, leading to high quantization errors, a loss of similarity information, and poor “recall,” meaning the system fails to consistently retrieve the true nearest neighbor vectors when a user performs a search. To address this problem, the described systems and methods utilize an Optimized Scalar Quantization (OSQ) process that compresses vectors more dynamically and accurately.

As an initial step in this optimized process, the system can receive a set of vectors and center the data by subtracting the centroid (the average or center point) of the dataset from each individual vector. For example, if a cluster of data points is far from the origin on a graph, subtracting the centroid shifts the cluster into a smaller, tighter space centered at the origin. This centering step minimizes the size of the space containing the vectors, which helps spread the values better across the quantization range and reduces compression errors. To ensure that accuracy is not lost during this shift, the system can calculate and store an additional value alongside the document, corresponding to the dot product of the centroid and the original vector. Caching this value (i.e., as metadata) allows the system to later recover the similarity distance without complex recalculations.

Building on this centered data, the system can then determine and adjust a scaling factor for each dimension of the vectors. A scaling factor in scalar quantization is the value that converts continuous vector components into discrete quantization levels, which can be defined as the interval width divided by the number of quantization steps. The scaling factor can determine how much a one-step change in the integer code corresponds to in the original floating-point space. Instead of using a single rigid rule across the entire dataset, the system can analyze the distribution of values in each vector (i.e., dimensions of the vector) and adjust the scaling factor based on the quantization error, scaling the values so that the statistical shapes (the moments) of all dimensions are matched. For instance, if the first dimension of a vector dataset ranges from 1 to 1000, while the second-dimension ranges from 1 to 2, the system will learn and apply a customized scaling factor for each dimension to compress them efficiently. Once these adjusted scaling factors are generated, the system can use them to create the final quantized vectors. When a user subsequently submits a search query, the query is quantized using those same adjusted per-dimension scaling factors, allowing the system to quickly and accurately retrieve the closest matches using fast, integer-based distance calculations. As used herein, a quantized vector is a compressed representation of a high-dimensional data vector that converts memory-intensive floating-point components into compact, discrete integer values. To accurately reconstruct mathematical similarity scores during a database search, this discrete vector is stored alongside specific cached metadata, which can include uniquely adjusted scaling factors, the dot product of a dataset centroid and the original vector, a cached sum of the quantized integer components, and optional quantized error terms for achieving fractional bit counts.

In some technical solutions, high-dimensional vectors are used to capture the important information and underlying concepts of the raw data they represent. For example, a vector might encapsulate the semantic meaning of a text document, the visual features of an image (such as a “red dress”), or a user’s past behavior to inform product recommendations. In some implementations, the system can be configured to receive or obtain a set of vectors. This set of vectors need not represent the entire dataset. The set of vectors can be either the complete corpus or a specific subset. For instance, when a vector database uses partition-based data structures, such as an Inverted File Index (IVF), the dataset is divided into smaller groups, and the system can receive and process a set of vectors corresponding to a single partition at a time.

Each vector within this set can comprise a plurality of dimensions. In technical terms, a dimension in a vector represents an individual numerical feature or component that defines the vector’s precise position in a multi-dimensional space. For example, if a vector represents a complex document, its hundreds of distinct dimensions (often between 384 and 960 dimensions in standard datasets) might correspond to various abstract linguistic features evaluated by the machine learning model. Additionally, this plurality of dimensions can comprise normalized dimensions, meaning the numerical features may be mathematically scaled to a standard, uniform range before the system processes them and determines their optimized scaling factors.

Once the set of vectors is received from a dataset, an initial translation or centering step can be performed to minimize quantization errors. The system translates the set of vectors by subtracting a centroid of the dataset from each individual vector. The centroid represents the average multi-dimensional point of the entire dataset, or a specific partition of the dataset when an index such as an IVF is used. By shifting each vector, mathematically mapping the vector to x to x - m, where m is the centroid, the system effectively minimizes the size of the space containing the data points. This centering step can ensure that the values are more evenly distributed across the quantization range, reducing quantization errors. To maintain accuracy during future searches, the system can compute and store an additional value for each vector, which represents the dot product between the centroid and the corresponding original vector.

Following this centering step, the system proceeds to determine a scaling factor for each dimension in the plurality of dimensions. A scaling factor is a learned value that adjusts the range of data in a specific vector dimension before quantization. The scaling factor can function to efficiently map the newly shifted floating-point values into a smaller set of discrete integer values, optimizing memory usage while maintaining high accuracy in vector search. The scaling factor should be understood to be different than the dataset centroid. While the centroid is a global, multi-dimensional point used to physically shift the entire dataset into a smaller space, the scaling factor is a dimension-specific value that defines the actual compression boundaries or intervals for that shifted data.

To initially determine these scaling factors, the system analyzes the distribution of component values within an individual vector. In some examples, the initialization process computes the optimal expectation values by assuming that the component data in the vector are normally distributed, which is an effective approximation for many machine learning embedding models. Relying on this assumption, the system can calculate the initial scaling boundaries (i.e., endpoints) based on the mean and standard deviation of the components in that specific vector. Furthermore, this initial calculation utilizes predefined mathematical constants (referred to as kₙ) that correspond directly to the number of bits being used to represent the vector components. For example, the constant used to initialize a 1-bit binary representation is k₁= 0.798, while a 2-bit representation uses k₂= 1.493. Once these initial values are established, the system adjusts the scaling factor based on a quantization error to generate an optimal separate interval per vector.

Instead of matching statistical moments across dimensions, the system minimizes a specific quantization error calculation for the vector using an iterative procedure. This optimization incorporates a tuning constant that allows the system to balance the error parallel to the vector with the error perpendicular to the vector. During this process, the system assigns the vector to its nearest grid point and adjusts the boundaries to find a global minimum, immediately exiting the iteration if the calculated error begins to increase.

In some implementations, in using the quantization error, the system can optimize the scaling factor by determining the best compression interval for an entire vector, applying this technique systematically across the received set of vectors. This compression interval is defined by lower and upper endpoints that establish the boundaries for the step size used to map a vector’s wide-ranging floating-point values into a smaller set of discrete integers. To determine the optimal endpoints for the vectors in the dataset, the system minimizes a quantization error metric that incorporates a predefined tuning constant. This tuning constant allows the system to deliberately balance the quantization error that runs parallel to the vector against the error that runs perpendicular to the vector. Because the actual nearest-neighbor matches are typically nearly parallel to a user’s query vector, setting this constant to a value less than 1 causes the system to prioritize reducing the parallel error across the set of vectors, which improves overall search retrieval accuracy.

To identify the best possible endpoints, the system can be configured to employ a two-step iterative procedure across the set of vectors. First, using the current endpoints, the system estimates the original vector by “snapping” the values to its nearest discrete grid point. Second, based on the newly assigned grid point, the system finds the global minimum of the error function to generate an updated pair of endpoints. The system then loops back to the first step using these new endpoints. However, because snapping values to a rigid grid does not mathematically guarantee that the overall error decreases at each iteration, the system actively checks the error after each pass. If the system detects that the quantization error is increasing, the system can exit the loop. By executing this iterative optimization across the entire set of vectors, the system effectively locks in the optimal interval and scaling factor for each vector, ensuring the vectors are compressed efficiently based on their specific magnitudes and distributions.

For example, a computing system can start a first iteration with an initial lower endpoint and an initial upper endpoint that define a compression interval for a vector. During this first step, the system assigns the vector’s floating-point values to a discrete grid based on that initial interval. After these values are assigned, the system evaluates the quantization error and calculates a global minimum to generate newly adjusted lower and upper endpoints. In a second iteration, the system uses this newly adjusted interval to assign the vector values to the grid once again. If the system determines that this new interval successfully decreased the overall quantization error, the system will continue the procedure to generate another set of adjusted endpoints for a third iteration. However, because assigning or snapping values to the nearest grid point does not guarantee that the error is minimized on every pass, if the system detects that the new endpoints increase the error, the system will exit the iterative loop and lock in the previous endpoints to produce the final quantized vector.

In some implementations, the system can be configured to separate a vector into one or more channels, wherein each channel can include one or more dimensions of the vector. To separate the vector into channels, a computing system divides the original high-dimensional data array into smaller, distinct groupings of dimensions. A “channel” is technically defined as a specific subset or partition of vector components grouped together for independent compression. To select which dimensions belong in which channel, a system can employ different strategies depending on the data distribution. For non-isotropic distributions, in which data are spread unevenly across dimensions, a system can use a mathematical technique called Singular Value Decomposition (SVD). SVD produces a transformation matrix whose columns are the singular vectors, sorted in descending order of their corresponding singular values. By transforming data vectors using this matrix before splitting, the system ensures accurate dot product calculations are preserved. Alternatively, a system can select channels by grouping strongly correlated vector components together, simply rearranging the order of components within the vector.

For example, a data vector can contain four dimensions: [1.5, 8.2, 1.7, 8.4]. If the first dimension (1.5) and the third dimension (1.7) share a strong mathematical correlation, a computing system can rearrange the vector into a new order, creating [1.5, 1.7, 8.2, 8.4]. The system then partitions the rearranged vector into two distinct channels. The first channel includes the strongly correlated components [1.5, 1.7], while the second channel includes the remaining components [8.2, 8.4]. To preserve mathematical accuracy during a database search, the system applies the same rearrangement and channel separation to all query and document vectors.

Once dimensions are partitioned into separate channels, the computing system independently calculates an optimal scaling factor, or compression interval, for each channel. An interval consists of a lower endpoint and an upper endpoint, which define a step size used to compress floating-point values into smaller discrete integers. To find the optimal endpoints for a given channel, the system performs an iterative mathematical procedure. First, the system calculates the initial endpoints using the mean and standard deviation of the data in that specific channel. Next, the system assigns the floating-point values to a discrete grid based on the current interval. The system then evaluates a quantization error calculation, factoring in a tuning constant to balance parallel and perpendicular errors, and finds a global minimum to generate newly adjusted endpoints. The system iterates through this grid assignment and error-minimization procedure until the calculated error begins to increase. Upon detecting an increase in error, the system immediately exits the loop, thereby locking in the optimal scaling factor for that specific channel.

For the previously described vector divided into two channels, a computing system stores the quantized vector components as integer values. Instead of retaining the original floating-point numbers, a database stores the compressed data for the first channel and the second channel as discrete integers within a fixed bit range.

To reconstruct floating-point estimates during a database search, the system retains a small number of corrective factors, which logically include the scaling factors or optimal quantization intervals. Specifically, the system may reference the calculated lower and upper endpoints for each separate channel. In some examples, the system may store a scale and offset to represent the scaling factor associated with the quantization interval.

The system may also cache specific floating-point values alongside the vector components to enable fast scalar multiplications and additions. One stored value can be the sum of the components making up the quantized vector. Retaining this sum requires one float of overhead, although the cached value can be compressed. A computing system computes the sum once during indexing and caches the result with the document. During a database search, a system uses the cached sum to perform fast scalar multiplications and additions, avoiding the need to recalculate the sum for every vector comparison. A second stored value can be a dot product calculation involving a global dataset centroid and the original uncompressed vector. Retaining this specific centroid dot product requires storing one extra floating-point value per document. Storing the centroid dot product allows a computing system to shift all vectors in a corpus prior to quantization. Shifting the vectors minimizes the size of a box containing the dataset. By retaining the centroid dot product, a system can successfully recover original dot product values and accurately compute vector similarity during a user query.

In some implementations, a system can achieve fractional bit counts by storing a base quantized representation of a vector and then storing additional correction information for only a subset of components. A fractional bit count refers to an average number of bits used per vector component that is not an integer, such as 1.2 bits per dimension. In an example implementation, each component of a vector may first be quantized using a 1-bit representation, where each value is converted to either a 0 or 1 depending on whether the component is above or below a threshold. This produces a compact binary vector that approximates the original floating-point vector.

In some implementations, after generating the base quantized vector, the system can compute a quantization error for each component by comparing the original vector values with the reconstructed values from the binary representation. Components with the largest errors can then be selected and encoded with additional bits to improve accuracy. For example, a vector with 1000 components may be stored using 1 bit per component (1000 bits total). If an additional 1-bit correction is stored for only the 200 components with the largest errors, the total storage becomes 1200 bits. This corresponds to an average of 1.2 bits per component, which is a fractional bit count. During similarity computation or vector reconstruction, the correction values can be combined with the base quantized vector to provide a more accurate estimate of the original vector while still maintaining a compact representation.

In some implementations, the system determines the scaling factor and corresponding compression boundaries based on the quantity of bits available for quantization. The selected number of bits directly changes the number of discrete levels or steps that the system can use to represent the original floating-point values. For example, compressing a vector component into a 1-bit representation provides two discrete levels (such as a 0 or a 1), whereas a larger bit depth, such as a 2-bit or 8-bit representation, provides a progressively larger number of discrete steps across the quantization range. By identifying the available bit depth, the system determines how many discrete integer levels exist within the compression interval, enabling accurate mapping of continuous floating-point data.

To set up this interval, the system determines an initial lower endpoint and an initial upper endpoint based on a statistical mean and a standard deviation of the data components. Because the chosen number of bits dictates the available quantization levels, this initial endpoint calculation incorporates a predefined mathematical constant that corresponds directly to the targeted bit count. For instance, when calculating the endpoints based on the assumption that the data is normally distributed, the system combines the mean and standard deviation with a constant of 0.798 for a 1-bit representation, or a constant of 1.493 for a 2-bit representation. By combining the vector’s specific mean and standard deviation with this bit-dependent constant, the system establishes highly accurate initial boundaries before beginning the iterative process of fine-tuning the optimal scaling factor.

As an illustrative example of the operations, a vector can include the dimensions [1.5, 8.2, 1.7, 8.4]. The mean of these components is 4.95, and the standard deviation is approximately 3.35. For a 1-bit quantization setup, the system multiplies the standard deviation (3.35) by the 1-bit constant (0.798), resulting in approximately 2.67. By subtracting and adding this value to the mean (4.95), the system establishes an initial compression interval from roughly 2.28 to 7.62. If the system uses a 2-bit representation instead, the system multiplies the standard deviation by the 2-bit constant (1.493) to get exactly 5.00, resulting in a wider initial interval spanning from -0.05 to 9.95. Once these bit-specific initial boundaries are calculated, the system initiates an iterative mathematical loop to continuously test, fine-tune, and lock in the adjusted endpoints based on minimizing the quantization error.

In some implementations, although the system is described as determining the initial values for the scaling factors and corresponding compression boundaries based on the standard deviation of the vector's components, other values or statistical metrics can be utilized for this initialization. For example, instead of relying on the standard deviation, the system can evaluate the initial boundaries based on the variance of the components. Additionally, the system can use other measures of a vector’s scale or spread, such as a per-vector magnitude or a vector norm. Furthermore, the system can employ specific predefined heuristics or other distribution-based metrics to establish these starting values rather than assuming a strictly normal distribution. By using these alternative measures of data dispersion and magnitude, the system can still establish highly accurate initial endpoints for the interval before starting the iterative mathematical optimization procedure.

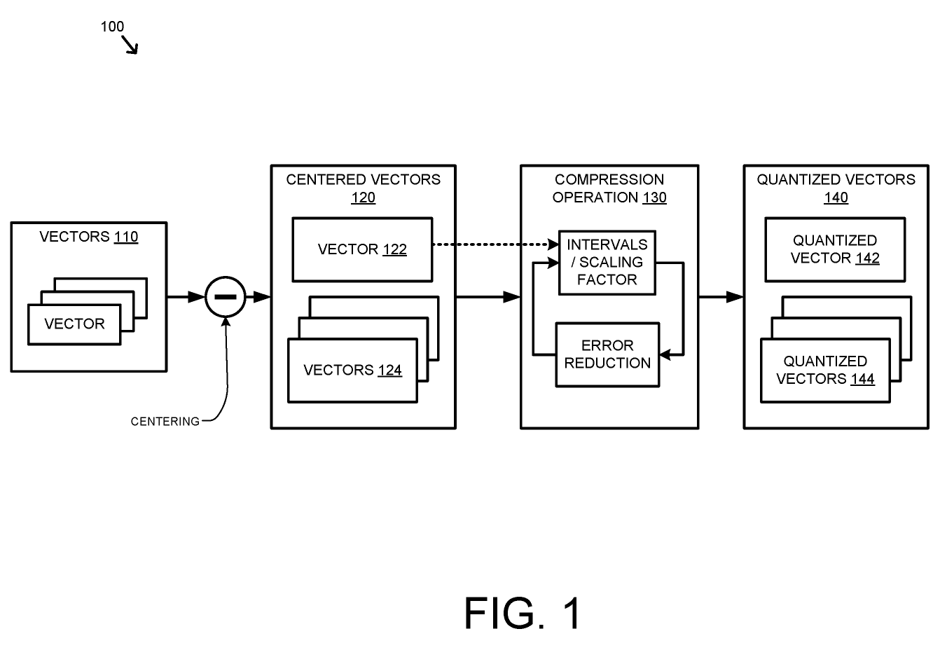

FIG. 1 illustrates an operational scenario 100 of providing scalar optimization according to an implementation. Operational scenario 100 includes vectors 110, centered vectors 120 with vector 122 and vectors 124, compression operation 130, and quantized vectors 140. Quantized vectors 140 further include quantized vector 142 and quantized vectors 144, wherein quantized vector 142 may include a different scaling factor than quantized vectors 144.

In operational scenario 100, vectors 110 representing high-dimensional data vectors can be received and processed to perform scalar optimization for vector compression. In some implementations, the vectors 110 can be transformed into centered vectors 120 by subtracting a representative value, such as a centroid, from each vector component to produce centered vector 122 and additional centered vectors 124. Centering the vectors can reduce variation in the component values and improve the efficiency of subsequent quantization. The centered vectors 120 can then be processed by compression operation 130, in which scalar quantization parameters, such as interval boundaries or scaling values, are determined to map floating-point vector components to discrete integer representations. Based on the determined quantization parameters, the system can generate quantized vectors 140 that represent compressed versions of the original vectors while preserving similarity relationships between vectors for efficient search or comparison operations.

In some implementations, to generate the centered vectors 120, a computing system can translate the vectors in a corpus to minimize the size of a bounding box containing the vectors. In a specific example, the system calculates a global centroid, representing the mathematical average of the entire corpus, and subtracts this centroid from each individual vector 110. By shifting the vectors prior to quantization, the system groups the data more tightly, improving compression. To ensure accurate vector similarity calculations can be recovered during a later search, the system can compute and cache additional values, such as a dot product between the global centroid and the original vector. Caching this value requires storing only one extra floating-point value alongside the compressed vector. Furthermore, if the system uses partitioned data structures for the database, such as an Inverted File (IVF) index, a separate centroid can be computed and subtracted for each partition.

Following the centering process, centered vectors 120 undergo a compression operation 130, where the system applies scalar quantization to convert the floating-point components into smaller discrete integers, such as 1-bit or 2-bit representations. During compression operation 130, the system determines an optimal quantization interval, comprising a lower boundary and an upper boundary, specifically for each individual vector. To initialize these boundaries, the system can assume that the component data within a given vector are normally distributed. Based on this assumption, the system calculates initial starting boundaries using the statistical mean and standard deviation of that vector’s components. Additionally, this initial calculation incorporates predefined mathematical constants that correspond to the specific number of bits chosen for compression. For example, the system may apply a constant of 0.798 for a 1-bit binary representation or 1.493 for a 2-bit representation to set the initial lower and upper endpoints.

Once the initial boundaries are established, compression operation 130 can be configured to use an iterative mathematical procedure to fine-tune and lock in the optimal scaling factors for the vector. The system seeks to minimize a specific quantization error that occurs when floating-point values are snapped to a discrete integer grid. To optimize this error, the system incorporates a tuning constant that balances the error running parallel to the vector against the error running perpendicular to the vector. During the iterative procedure, the system assigns the vector components to their nearest grid points based on the current boundaries and computes the global minimum of the quantization error. The system continuously loops through this grid assignment and error-minimization process to dynamically adjust the boundaries, but iteratively checks the error and exits the loop if the calculated error begins to increase. Upon exiting the iteration, the system generates the final quantized vectors 140 using the optimized, individual interval for each vector.

In addition to processing a vector as a single unit, a computing system can achieve greater compression accuracy by separating the vector’s components into smaller groupings, referred to as channels. According to the claims, a vector can be separated into at least a first channel and a second channel, wherein each channel comprises one or more dimensions of the plurality of dimensions. When using this channel-quantization approach, the system computes an optimal quantization interval independently for each channel. For example, the system determines a first scaling factor for the first channel and a second scaling factor for the second channel. By applying these uniquely adjusted scaling factors to specific subsets of the vector’s components, the system determines the final quantized vector.

To determine how the different dimensions are grouped into these channels, the system can evaluate criteria such as the mathematical correlation among individual components. Specifically, the system can rearrange the order of the plurality of dimensions in the vector to group strongly correlated components together prior to separating the vector into the individual channels. Because any permutation of a vector’s components trivially preserves the underlying dot product calculations, this rearrangement allows the system to create highly effective partitions, provided the exact same rearrangement is subsequently applied to both the query vectors and the document vectors during a search.

Alternatively, for vectors with non-isotropic distributions, where the data is spread unevenly across dimensions, the system can apply a mathematical transformation to create effective partitions. Specifically, the system can utilize a heuristic called Singular Value Decomposition (SVD). The system can use a transformation matrix whose rows are singular vectors of a data covariance matrix, sorted by their corresponding singular values. By transforming the data vectors using this specific matrix prior to quantizing and splitting the dimensions into channels, the system can intelligently group the components while ensuring that the original dot product values can still be accurately recovered during nearest neighbor searches.

As an illustrative example, a computing system can be configured to split a vector into four distinct channels, computing optimal quantization intervals independently for each channel. To determine how the vector’s dimensions are partitioned among these four channels, the system assigns one or more dimensions to each channel. The system can intelligently partition the dimensions by evaluating the mathematical correlation between individual components and rearranging the dimensions in the vector to keep strongly correlated components together prior to separation. Furthermore, for vectors with uneven or non-isotropic data distributions, the system can multiply the vectors by a SVD matrix to mathematically transform the data prior to splitting the vector into the four channels, which creates highly effective partitions while preserving the ability to accurately recover the original dot product similarity calculations during a user query.

In some implementations, when a vector is quantized, the system can be configured to store various values to support reassembling a vector and performing accurate similarity queries (i.e., stored as part of the metadata with the vector). Because the system can translate the dataset by subtracting a global centroid from each vector prior to quantization, the system can store information to accurately reverse this shift during a search. To achieve this, the system can compute an additional value, the dot product of the centroid and the original uncompressed vector, and store the additional value alongside the quantized document. Furthermore, the system computes the sum of the components of the quantized vector exactly once during indexing. By caching this component sum with the document, which requires only a single float of overhead storage, the system avoids recalculating the value for every vector comparison.

Additionally, the system can calculate and store error-correction terms to further improve the accuracy of the reconstructed vectors. For instance, to achieve an effective representation between one and two bits, the system can identify the vector components with the largest compression errors across the corpus, define a projection matrix, and store a quantized error term to correct the original estimates. During a nearest-neighbor search, these stored per-document values are combined with precomputed query terms, such as the sum of the query’s quantized components and the dot product between the query and the centroid. This allows the system to combine the fast dot products of the quantized vectors with highly efficient scalar additions and multiplications to accurately reconstruct the maximum inner product similarity scores.

In some implementations, to further refine the accuracy of the quantized vectors 140 generated in operational scenario 100, the system can perform a corpus-wide error correction procedure. This technique is particularly useful for achieving a fractional bit count—an average number of bits per vector component that is not a whole integer, such as 1.2 bits. After computing the base quantized vectors for the dataset (e.g., using a standard 1-bit representation), the system computes the remaining quantization error for each vector, defined as the difference between the original floating-point vector and its reconstructed quantized estimate. Rather than correcting every dimension equally, the system analyzes this remaining error across the entire corpus to selectively identify the specific vector components that exhibited the largest compression errors. Once these components are identified globally, the system uses them to define a projection matrix that mathematically projects and isolates this specific remaining error for each individual vector. The system then quantizes this isolated error using the same iterative optimization procedure to generate a quantized error term, which is stored alongside the base quantized vector. For example, if a vector comprises 1000 components initially compressed at 1 bit per component (totaling 1000 bits), the system might identify the 200 components with the highest error across the corpus and store an additional 1-bit quantized error term for only those 200 components. This results in a total storage of 1200 bits, effectively achieving a highly accurate 1.2 fractional bit count. During a subsequent similarity search, the system uses these stored quantized error terms to correct the initial base estimates, effectively restoring the magnitude and precision that was lost during the first compression phase without incurring the full memory cost of a global 2-bit representation.

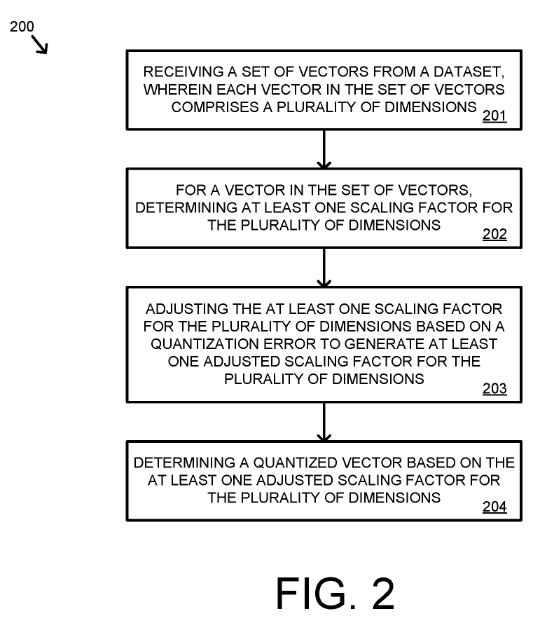

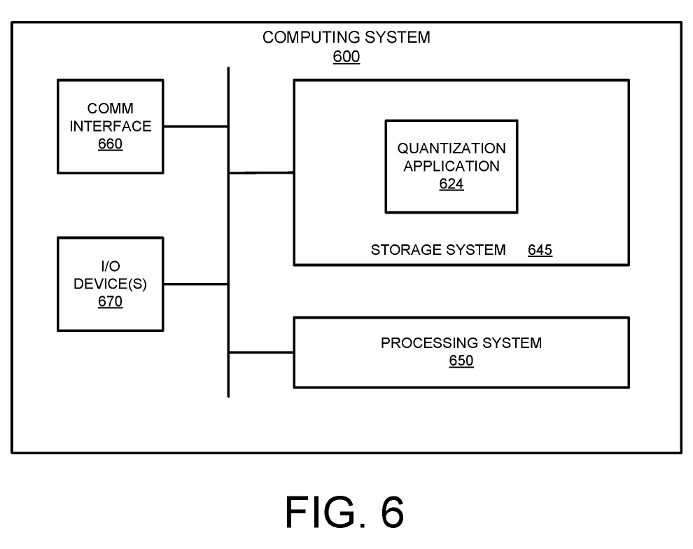

FIG. 2 illustrates a method 200 of providing scalar quantization according to an implementation. The steps of method 200 can be performed by a computing system, such as computing system 600 of FIG. 6.

Method 200 includes receiving a set of vectors from a dataset, wherein each vector in the set of vectors comprises a plurality of dimensions at step 201. For a vector in the set of vectors, the method can further include determining at least one scaling factor for the plurality of dimensions at step 202 and adjusting the at least one scaling factor for the plurality of dimensions based on a quantization error to generate at least one adjusted scaling factor for the plurality of dimensions a step 203. Once adjusted, method 200 further comprises determining a quantized vector based on the at least one adjusted scaling factor for the plurality of dimensions at step 204.

In some implementations, method 200 begins at step 201 by receiving a set of vectors from a dataset, wherein each vector in the set of vectors comprises a plurality of dimensions. These vectors are typically generated by machine learning models and represent high-dimensional data that captures important conceptual information about documents, images, or products.

To improve the efficiency of the quantization process, the system can apply a translation to the set of vectors before determining the scaling factors. Specifically, the system calculates a global centroid representing the mathematical average of the dataset and translates the set of vectors by subtracting this centroid from each vector. This shifts the vectors to minimize the size of a bounding box containing the data, effectively grouping the points together for better compression.

Because this translation shifts the original data, the system may ensure the original vector similarity relationships can be accurately recovered during a later user search. To support this, the method further includes determining an additional value for the vector, which is the dot product of the centroid and the original uncompressed vector. By storing this additional value with the quantized vector, the system can accurately recreate similarity scores at search time using just one extra floating-point value of overhead per document.

At step 202, the method involves determining at least one scaling factor for the plurality of dimensions. In some implementations, this step serves as an initialization step in which the system determines initial lower and upper endpoints for the scaling boundaries. The system calculates these initial endpoints assuming the component data are normally distributed, using the statistical mean and standard deviation of the vector’s components.

Furthermore, determining this initial scaling factor at step 202 incorporates identifying a quantity of bits available for quantization. The calculation utilizes predefined mathematical constants that correspond directly to the targeted bit count. For example, initializing a 1-bit binary representation uses a constant of 0.798, while a 2-bit representation uses 1.493.

Moving to step 203, the system fine-tunes this initial interval by adjusting at least one scaling factor based on a quantization error to generate at least one adjusted scaling factor. This adjustment relies on an iterative mathematical optimization procedure that seeks to minimize the error introduced by snapping floating-point values to discrete integer grids.

During the optimization in step 203, the system evaluates the quantization error by using a tuning constant to balance the error running parallel to the vector against the error running perpendicular to the vector. The system iteratively assigns the vector components to their nearest grid points, finds the global minimum of the error, and adjusts the scaling boundaries accordingly. To prevent degradation, the system checks the error during each iteration and immediately exits the loop if the calculated error increases, thereby locking in a separate, optimal interval specifically adjusted for that individual vector.

At step 204, the method concludes the core compression phase by determining a quantized vector based on the at least one adjusted scaling factor for the plurality of dimensions. By applying these optimized boundaries, the system effectively rounds the 32-bit floating-point components into compact discrete integers. This scalar quantization significantly reduces the memory requirements of the vector database and enables much faster, cheaper vector searches.

To achieve even greater accuracy, Method 200 can be adapted to perform channel quantization by dividing the vector into smaller subsets. In this configuration, the system separates the vector into at least a first channel and a second channel prior to determining the scaling factors, with each channel comprising one or more dimensions. The system then calculates uniquely adjusted intervals for each subset, yielding a first scaling factor for the first channel and a second scaling factor for the second channel.

To determine which dimensions are grouped together into these channels, the system can rely on specific mathematical criteria. For instance, the system can rearrange the order of the plurality of dimensions in the vector to group strongly correlated components together prior to separating the vector into the individual channels. Alternatively, for data that spreads unevenly (non-isotropic distributions), the system can mathematically transform the data vectors prior to quantization using a SVD matrix. Both rearrangement and SVD transformations preserve the ability to accurately recover the original dot product values during a search.

Ultimately, these combined steps allow the database to efficiently process user queries. When a user query is received, the query is converted into a query vector and quantized using a similar procedure. Because the stored documents were optimally compressed using individual intervals or specialized channels, the system can determine the closest matching documents by performing fast SIMD-accelerated dot products of the integer vectors, combining them with the cached metadata values (such as the pre-calculated dot product of the centroid) to quickly and accurately calculate similarity scores.

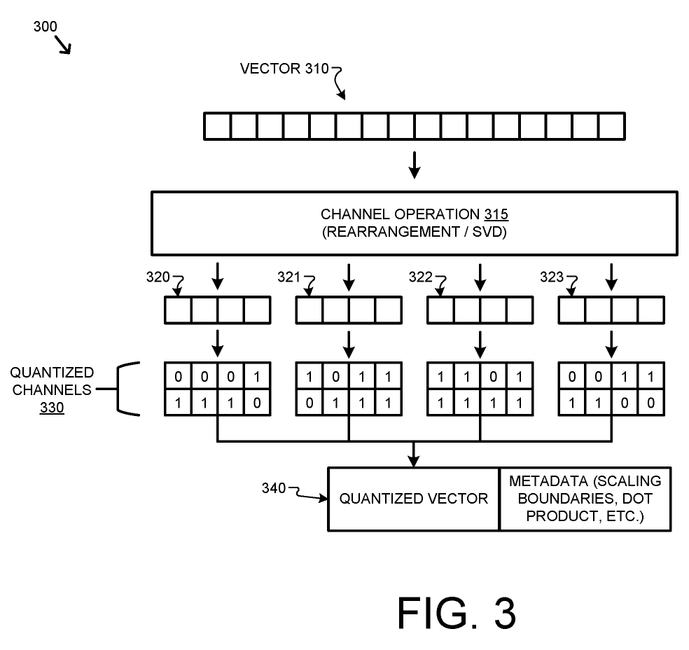

FIG. 3 illustrates an operational scenario 300 of separating a vector into channels according to an implementation. Operational scenario 300 includes vector 310, channel operation 315, channels 320-323, quantized channels 330, and quantized vector 340. Operational scenario 300 can be performed by computing system 600 of FIG. 6.

In operational scenario 300, vector 310 represents a high-dimensional data structure, such as one generated by a machine learning model to capture important information about semantic concepts, images, or products. To improve quantization accuracy, the system can partition vector 310 into multiple subsets and compute compression parameters optimized for each subset.

The separation of vectors into distinct channels can be an adaptable feature, meaning channel quantization can be used when necessary. The optimized scalar quantization procedure is designed to compute a single, separate interval for each vector to compress floating-point values into integers. However, the procedure naturally generalizes to channel quantization, allowing the system to optionally invoke channel operation 315 when a single vector-wide compression interval fails to provide sufficient search recall, or when the underlying data exhibits complex, uneven distributions.

When channel operation 315 is invoked, operation 315 receives vector 310 and separates the vector into a plurality of channels, such as channels 320, 321, 322, and 323. As defined herein, a channel comprises one or more dimensions of the plurality of normalized dimensions making up the original vector. For instance, the system separates the vector into at least a first channel and a second channel prior to determining the scaling factors, wherein the first channel and the second channel each comprise specific, assigned dimensions of the original vector.

To determine how the dimensions are separated and assigned to channels 320-323, channel operation 315 can be configured to evaluate various mathematical criteria. One effective strategy for identifying these channels is to evaluate correlations among the vector components. The system can rearrange the order of the plurality of dimensions in vector 310 to strategically group strongly correlated components together prior to separating the vector into the individual channels. Because any permutation of a vector’s components trivially preserves the underlying mathematical dot product, the system can freely reorganize the dimensions to create highly effective channel partitions, provided the exact same rearrangement is applied to query vectors during a search.

Alternatively, the channels can be determined and separated using advanced mathematical transformations, which is particularly useful for non-isotropic vector distributions in which the data are spread unevenly. In these cases, a heuristic that can produce effective partitions is to use SVD. The system can generate a transformation matrix whose rows consist of singular vectors derived from the data covariance matrix. Multiplying vector 310 by this transformation matrix prior to quantization effectively splits the data into channels 320-323, while still guaranteeing that the system can recover the original dot product values.

Once vector 310 is separated into channels 320-323, the system can be configured to compute optimal quantization intervals independently for each individual channel. For each channel, the system determines an initial lower endpoint and an initial upper endpoint based on the mean and standard deviation of the component data in that channel. This initialization can use a predefined constant that specifies the number of bits available for quantization, such as utilizing a constant of 0.798 for a 1-bit representation or 1.493 for a 2-bit representation.

After determining the initial scaling factors, the system can be configured to adjust the scaling factors for each channel based on a quantization error. The system performs an iterative procedure to minimize the error between the original floating-point components in the channel and the discrete integer grid. By balancing the error parallel to the vector with the error perpendicular to the vector, the system generates at least one adjusted scaling factor tailored to that subset of dimensions. Consequently, a first adjusted scaling factor corresponds to the first channel, a second adjusted scaling factor corresponds to the second channel, and so forth, resulting in the optimized quantized channels 330.

To support efficient queries and allow the system to recreate the similarity relationships of the original vector 310, specific metadata may be stored as part of the quantized channels 330 and the final quantized vector 340. Foremost, the system may store the adjusted scaling boundaries (the optimal quantization intervals) independently computed for each channel. Storing these per-channel intervals allows the search algorithm to properly weight and reconstruct the discrete integers during similarity calculations.

Furthermore, additional values (i.e., as part of the metadata) are stored with quantized vector 340 to correct for global data transformations. For example, if the system translates the set of vectors prior to determining the scaling factors by subtracting a global centroid of the dataset from vector 310, the system may store an additional value comprising a dot product of the centroid and the vector. Storing this dot product requires only one extra floating-point value of overhead per vector. The system can also compute the sum of the components of the quantized vector when the document is indexed and caches sum alongside quantized vector 340, which similarly requires only one float of overhead in storage.

The system may also store specialized error correction metrics as part of quantized vector 340. If the system is configured to achieve an effective bit count between 1 and 2 bits, the system can compute the remaining quantization error after the intervals are locked in. The system chooses the components with the largest error across the corpus, defines a projection matrix, and generates a quantized error term. This quantized error term is stored with the quantized vector to correct the final estimates during a similarity search.

In some implementations, to achieve an effective bit count between 1 and 2 bits, the system can perform a specific error correction procedure to address the parts of the data that were least accurately compressed. After computing the initial optimal quantized vector, the system computes the remaining quantization error (i.e., the mathematical difference between the original floating-point vector and its quantized estimate). Rather than treating all errors equally, the system analyzes the corpus as a whole to choose the specific vector components that exhibit the largest error.

Once these components are identified, the system uses them to define a projection matrix. For each vector, the system mathematically projects and isolates this specific remaining error, quantizes it using the same optimization procedure, and generates a quantized error term. Finally, the system uses this newly quantized error term to correct the initial estimates of the original vector, effectively restoring the magnitude and accuracy lost during the initial compression phase. Although demonstrated between 1 and 2 bits, similar operations can be performed across different amounts of quantization (e.g., 2 and 3 bits).

Following the independent optimization of each channel, the system determines quantized vector 340 based on the adjusted scaling factors for the plurality of dimensions across all quantized channels 330. Quantized vector 340 represents a compressed iteration of vector 310, relying on discrete bit integers rather than memory-intensive 32-bit floating-point values. Because the quantization parameters were optimized per-channel, quantized vector 340 maintains a high degree of fidelity to the original data.

Ultimately, this channel-based quantization framework allows for exceptionally fast and accurate data retrieval. When a query vector is received, it undergoes the identical channel separation operations, including any component rearrangements or SVD transformations. The system then utilizes SIMD-accelerated implementations to execute rapid dot products between the quantized query channels and the stored quantized channels 330. By combining these fast dot products with stored overhead values, such as the centroid dot product and the component sums, the system can execute fast scalar multiplications and additions to accurately reconstruct the maximum inner-product similarity scores.

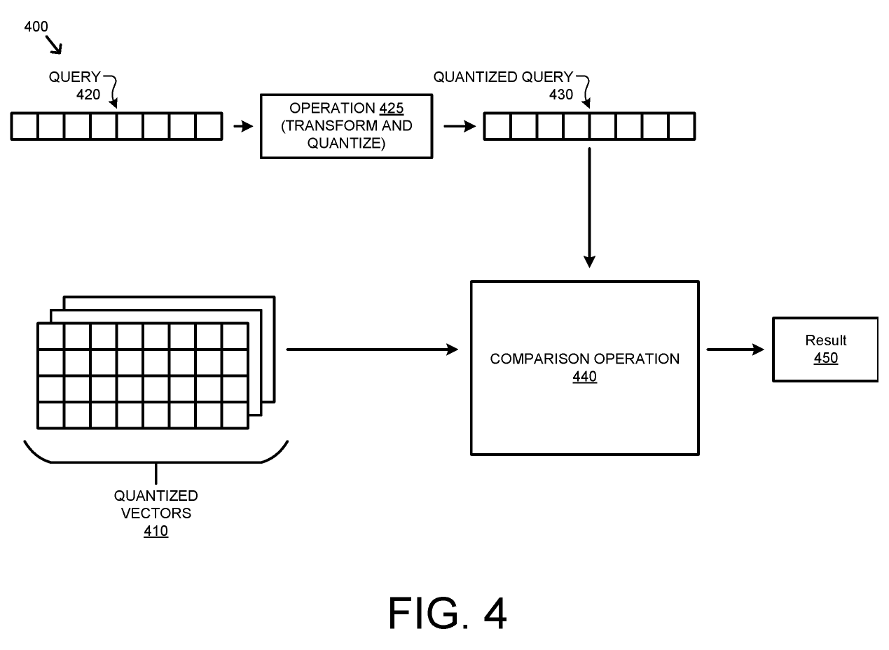

FIG. 4 illustrates an operational scenario 400 of performing a search according to an implementation. Operational scenario 400 includes quantized vectors 410, query 420, operation 425, quantized query 430, comparison operation 440, and result 450.

As previously described, quantized vectors 410 represent a large collection of vectors within a database that have been compressed into discrete integer values to reduce memory requirements and query latency. These stored vectors were processed offline by determining at least one scaling factor for a plurality of dimensions, and adjusting that factor based on a quantization error to generate an optimal adjusted scaling factor.

Operational scenario 400 begins with receiving query 420. Query 420 typically originates from a user request, such as a semantic retrieval question, an image search (for example, searching for “red dresses”), or a request for product recommendations. To process this request, the system first converts the user’s input into a high-dimensional floating-point query vector that captures the important conceptual information of the original query.

Once query 420 is converted into a vector, the system applies operation 425 to prepare it for comparison against the stored database. If the system previously utilized advanced partitioning strategies to index the dataset, operation 425 applies matching mathematical transformations to the query vector. For instance, if the original vectors were rearranged to group correlated components together prior to separating the vector into channels, or if they were transformed using a SVD matrix, the exact same permutation or transformation is applied to the query vector to preserve the underlying mathematical dot products.

Furthermore, operation 425 accounts for any global translations previously applied to the dataset. In implementations where the set of vectors was translated by subtracting a global centroid of the dataset from each vector, the system must prepare to reverse this shift. During operation 425, the system calculates a query-specific correction value by computing the dot product of the dataset centroid and the query vector. If the data store uses a partition-based index, such as an Inverted File (IVF) index, the system computes this centroid dot product separately for each individual partition being searched.

Following these preparatory transformations, operation 425 quantizes the query vector to generate quantized query 430. Similar to the offline compression of the document vectors, this involves representing the query vector’s floating-point components with smaller bit integer values, such as 1-bit or 2-bit representations. By converting the query into the same quantized space as the stored documents, the system ensures that it can leverage highly efficient integer math during the comparison phase.

To maximize the speed of the upcoming search, the system also computes an additional overhead value for quantized query 430 exactly once upfront, rather than recalculating it for every single document comparison. Specifically, the system calculates the sum of the components of the quantized query vector. By determining this sum and the centroid dot product prior to the search, the system dramatically reduces the computational burden required during the thousands or millions of vector comparisons that follow.

With quantized query 430 fully prepared, the system initiates comparison operation 440. Comparison operation 440 involves executing a nearest neighbor search to find the most mathematically similar document vectors within the data store. Because both the query and the stored vectors are now represented as compact integers, comparison operation 440 can utilize Single Instruction, Multiple Data (SIMD) accelerated implementations to perform fast dot products of the quantized vectors, bypassing the slower latency of standard floating-point operations.

While the core of comparison operation 440 relies on these fast integer dot products, the system must accurately reconstruct the original floating-point similarity scores—typically a Maximum Inner Product (MIP) calculation. To achieve this, the system executes fast scalar multiplications and additions that combine the SIMD integer dot product with the pre-calculated query terms and the cached metadata stored alongside quantized vectors 410.

Specifically, the system pulls the additional values stored with the quantized vector, which comprise the dot product of the centroid and the original uncompressed vector, as well as a cached sum of the document’s quantized components. By merging these stored document values with the upfront query calculations, the scalar additions effectively reverse the dataset centering and correct for the quantization grid, yielding a highly accurate estimation of the true mathematical distance between the original vectors.

Comparison operation 440 is often guided by specialized data structures within the vector database to avoid exhaustive brute-force searches. Popular choices include partition-based indices like IVF or graph-based indices like Hierarchical Navigable Small World (HNSW) graphs. By navigating these structures using the fast, reconstructed MIP scores, the system can efficiently isolate the specific neighborhood of vectors that most closely match quantized query 430.

Finally, the search process concludes by returning result 450. Result 450 comprises a specific subset of the retrieved vectors that represent the closest matches to the user’s initial query. Because the underlying procedure carefully determines and adjusts scaling factors based on quantization error for a single vector or its corresponding channels, the quantized search preserves an exceptionally high degree of fidelity to the original floating-point data. Consequently, result 450 achieves effective recall, returning the most relevant semantic documents, images, or recommendations, while benefiting from the massive reductions in memory and query latency afforded by scalar quantization.

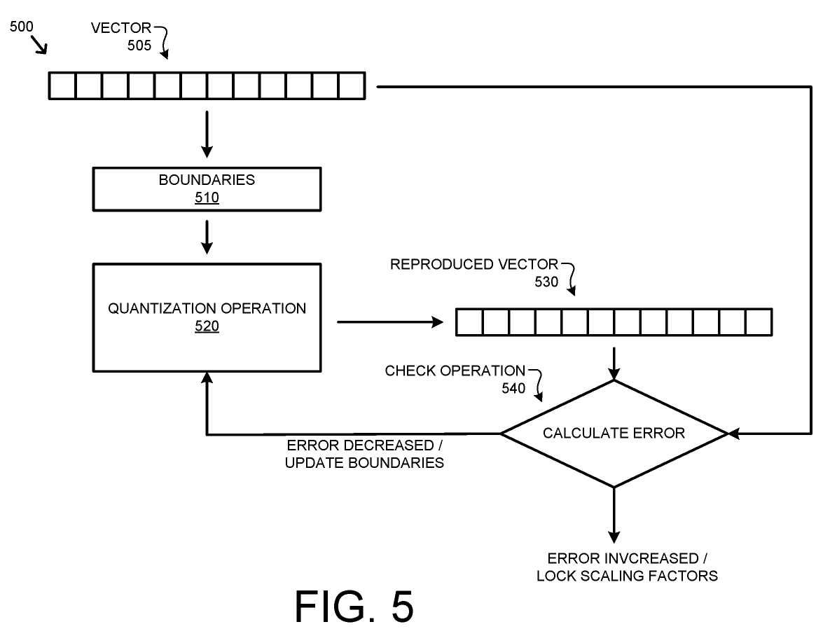

FIG. 5 illustrates an operational scenario 500 of performing iterative quantization improvement according to an implementation. Operational scenario 500 includes vector 505, boundaries 510, quantization operation 520, vector 530, and check operation 540 that compares the reproduced vector 530 with vector 505. This scenario depicts the iterative process of fine-tuning the compression boundaries. In the present example, operational scenario 500 depicts adjusting the lower and upper endpoints of a quantization interval to minimize information loss when converting floating-point values to discrete integers.

In operational scenario 500, vector 505 represents the original high-dimensional floating-point vector. To prepare for optimal compression, vector 505 may have already undergone a centering step where a global centroid of the dataset was subtracted from its components. This centering minimizes the bounding box containing the data and ensures the component values are better spread across the available quantization range, allowing the quantization process to adapt to the magnitude of the vector.

Before the iterative optimization begins, the system establishes initial scaling factors, represented as boundaries 510. This initialization relies on the assumption that the component data within vector 505 are normally distributed, which serves as a good approximation for many embedding models. The system calculates an initial lower endpoint and an initial upper endpoint based on the mean and standard deviation of the vector’s dimensions. This calculation also utilizes a predefined constant that directly corresponds to the number of bits used for compression, such as 0.798 for a 1-bit representation or 1.493 for a 2-bit representation.

Once the initial boundaries 510 are set, the system initiates quantization operation 520. Quantization operation 520 is a mathematical loop designed to evaluate and minimize a specific quantization error. Because vector similarity will eventually be calculated using Maximum Inner Product (MIP) queries, the system incorporates a tuning constant into the error calculation. This constant allows the system to trade or balance the error running parallel to the vector with the error running perpendicular to it. Since the actual nearest vectors in an MIP search are typically nearly parallel to the query vector, setting it to a value less than 1 (such as 0.1) effectively prioritizes and reduces the error for vectors near parallel the user query.

During the quantization operation 520, the system iteratively assigns the components of the vector to their nearest discrete grid points. This grid is defined by the current upper and lower boundary endpoints (mathematically represented as a and b). By snapping the floating-point values to this grid, the system temporarily establishes how the integer representation will look under the current scaling factors.

Based on this grid assignment, the system generates reproduced vector 530, which acts as the best mathematical estimate of the original floating-point vector reconstructed from its quantized counterpart. With this assignment in place, quantization operation 520 calculates the global minimum of the quantization error. Because this error function is quadratic with respect to the endpoints, the system can compute new, updated boundary values for the next iteration that aim to further lower the overall error.

However, the act of snapping floating-point values to a rigid integer grid does not inherently guarantee that the error function is minimized on every single iteration. Therefore, the system relies on the check operation 540 to monitor the optimization trajectory. Check operation 540 systematically evaluates the error of the reproduced vector 530 against the original vector 505 to see if the overall quantization error has increased or decreased.

If check operation 540 determines that the quantization error has decreased, the system loops back to quantization operation 520, using the newly calculated boundary endpoints to re-assign the components to the grid and find an even better minimum. Conversely, if check operation 540 determines that the calculated error has increased, it immediately exits the iteration loop. By exiting the loop at the first sign of increasing error, the system successfully locks in the adjusted scaling factors, ensuring the final quantized vector maintains the highest possible accuracy for subsequent vector searches.

FIG. 6 illustrates a computing system 600 for providing scalar quantization according to an implementation. Computing system 600 represents any computing device or devices with which the various operational architectures, processes, scenarios, and sequences disclosed herein for quantizing vectors can be implemented. Computing system 600 includes storage system 645, processing system 650, communication interface 660, and input/output (I/O) device(s) 670. Processing system 650 is operatively linked to communication interface 660, I/O device(s) 670, and storage system 645. In some implementations, communication interface 660 and/or I/O device(s) 670 may be communicatively linked to storage system 645. Computing system 600 may further include other components, such as a battery and enclosure, which are not shown for clarity.

Communication interface 660 comprises components that communicate over communication links, such as network cards, ports, radio frequency, processing circuitry, software, or some other communication devices. Communication interface 660 may be configured to communicate over metallic, wireless, or optical links. Communication interface 660 may be configured to use Time Division Multiplex (TDM), Internet Protocol (IP), Ethernet, optical networking, wireless protocols, communication signaling, or some other communication format – including combinations thereof. Communication interface 660 may be configured to communicate with external devices, such as servers, client devices, or other computing devices.

I/O device(s) 670 may include peripherals of a computer that facilitate the interaction between the user and computing system 600. Examples of I/O device(s) 670 may include keyboards, mice, trackpads, monitors, displays, printers, cameras, microphones, external storage devices, sensors, and the like. I/O device(s) 670 can be omitted in some examples.

Processing system 650 comprises microprocessor circuitry (e.g., at least one processor) and other circuitry that retrieves and executes operating software (i.e., program instructions) from storage system 645. Storage system 645 may include volatile and nonvolatile, removable, and non-removable media implemented in any method or technology for storage of information, such as computer-readable instructions, data structures, program modules, or other data. Storage system 645 may be implemented as a single storage device but may also be implemented across multiple storage devices or sub-systems. Storage system 645 may comprise additional elements, such as a controller to read operating software from the storage systems. Examples of storage media (also referred to as computer-readable storage media) include random access, read-only memory, magnetic disks, optical disks, and flash memory, as well as any combination or variation thereof, or any other type of storage media. In some implementations, the storage media may be non-transitory. In some instances, at least a portion of the storage media may be transitory. In no case is the storage media a propagated signal.

Processing system 650 is typically mounted on a circuit board that may also hold the storage system. The operating software of storage system 645 comprises computer programs, firmware, or other machine-readable program instructions. The operating software of storage system 645 comprises quantization application 624. The operating software on storage system 645 may further include an operating system, utilities, drivers, network interfaces, applications, or other software. When read and executed by processing system 650, the operating software on storage system 645 directs computing system 600 to implement the browser data store operations as described herein. In at least one implementation, the operating software can provide method 200 described in FIG. 2.

In at least one implementation, quantization application 624 directs processing system 650 to receive a set of vectors from a dataset, wherein each vector in the set of vectors comprises a plurality of dimensions, which may include normalized dimensions. To prepare the data for optimal compression, the quantization application 624 can direct the processing system 650 to translate the set of vectors prior to determining the scaling factors by subtracting a global centroid of the dataset from each vector in the set. By shifting the vectors to minimize the size of a bounding box containing the data, the system ensures the component values are better spread across the available quantization range. To ensure accurate vector similarity calculations can be recovered later, the processing system 650 determines an additional value for the vector comprising a dot product of the centroid and the uncompressed vector, storing this extra floating-point value alongside the final quantized vector.

For a given vector in the set, the quantization application 624 directs the processing system 650 to determine at least one scaling factor for the plurality of dimensions. This can involve calculating an initial lower endpoint and an initial upper endpoint based on the assumption that the component data are normally distributed. The system relies on the mean and the standard deviation of the vector’s dimensions, as well as predefined mathematical constants that correspond to a specific quantity of bits available for quantization.

Once initialized, the quantization application 624 directs the processing system 650 to adjust the at least one scaling factor based on a quantization error to generate at least one optimally adjusted scaling factor for the plurality of dimensions. The system executes an iterative procedure that minimizes the error between the original floating-point components and the discrete integer grid. During this optimization, the processing system 650 uses a tuning constant to balance the error parallel to the vector against the error perpendicular to the vector, effectively prioritizing the accuracy of nearly parallel vectors for Maximum Inner Product (MIP) queries. The system assigns the vector components to the nearest grid points, computes a global minimum of the error, and immediately exits the iteration if the calculated error begins to increase, thereby successfully locking in a uniquely adjusted interval for the vector.

With the optimal boundaries established, the quantization application 624 directs the processing system 650 to determine a quantized vector based on the at least one adjusted scaling factor. This operation snaps the memory-intensive 32-bit floating-point values into a smaller set of discrete integer values (e.g., 1-bit or 2-bit representations), significantly reducing the memory requirements of the vector database while allowing the quantization process to adapt to the magnitudes of different vectors.

In some configurations, to achieve even greater accuracy, the quantization application 624 can direct the processing system 650 to perform channel quantization. Here, the system separates the vector into at least a first channel and a second channel prior to determining the scaling factors, with each channel comprising one or more dimensions of the plurality of dimensions. The system determines uniquely adjusted parameters for each subset, yielding a first scaling factor for the first channel and a second scaling factor for the second channel. To optimize how these partitions are formed, the processing system 650 can evaluate correlations and rearrange the order of the dimensions to group strongly correlated components together, or the system can apply a SVD matrix to mathematically transform non-isotropic data prior to the split.

Ultimately, the quantization application 624 directs the processing system 650 to utilize these discrete quantized vectors and their cached metadata to rapidly process user queries. By converting incoming queries into the same compressed integer space, the system can execute highly efficient Single Instruction, Multiple Data (SIMD) accelerated dot products. The processing system 650 combines these fast integer comparisons with the stored centroid dot products and cached component sums to accurately reconstruct maximum inner product similarity scores, enabling faster and cheaper approximate nearest neighbor (ANN) searches while preserving exceptional recall rates.

Below are example clauses associated with the present disclosure. The described clauses should not be considered exhaustive.

Clause 1. A method comprising: receiving a set of vectors from a dataset, wherein each vector in the set of vectors comprises a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

Clause 2. The method of clause 1, wherein the plurality of dimensions comprises a plurality of normalized dimensions.

Clause 3. The method of clause 1, wherein determining the at least one scaling factor comprises determining an initial lower endpoint and an initial upper endpoint based on a mean and a standard deviation.

Clause 4. The method of clause 3, wherein determining the at least one scaling factor comprises identifying a quantity of bits available for quantization.

Clause 5. The method of clause 1, further comprising translating the set of vectors prior to determining the at least one scaling factor by subtracting a centroid of the dataset from each vector in the set of vectors.

Clause 6. The method of clause 1, wherein the at least one scaling factor comprises a first scaling factor and a second scaling factor, and wherein the method further comprises: separating the vector into at least a first channel and a second channel prior to determining the at least one scaling factor, wherein the first channel and the second channel each comprise one or more dimensions of the plurality of dimensions, wherein the first scaling factor corresponds to the first channel, and wherein the second scaling factor corresponds to the second channel.

Clause 7. The method of clause 6, further comprising: causing an update to an order of the plurality of dimensions in the vector to group dimensions with similar component values together prior to separating the vector into at least the first channel and the second channel.

Clause 8. The method of clause 1, further comprising: subtracting a centroid of the dataset from the vector prior to determining the at least one scaling factor; determining an additional value for the vector, wherein the additional value comprises a dot product of the centroid and the vector; and storing the additional value with the quantized vector.

Clause 9. The method of clause 1, further comprising: for a second vector in the set of vectors: determining at least one additional scaling factor for the plurality of dimensions associated with the second vector; adjusting the at least one additional scaling factor for the plurality of dimensions associated with the second vector based on a second quantization error to generate at least one additional adjusted scaling factor for the plurality of dimensions, wherein the at least one additional adjusted scaling factor is different than the at least one scaling factor; and determining a second quantized vector based on the at least one additional adjusted scaling factor for the plurality of dimensions associated with the second vector.

Clause 10. A computer-readable storage medium having program instructions stored thereon that, when executed by at least one processor, direct the at least one processor to perform a method, the method comprising: receiving a set of vectors from a dataset, wherein each vector in the set of vectors comprises a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

Clause 11. The computer-readable storage medium of clause 10, wherein the plurality of dimensions comprises a plurality of normalized dimensions.

Clause 12. The computer-readable storage medium of clause 10, wherein determining the at least one scaling factor comprises determining an initial lower endpoint and an initial upper endpoint based on a mean and a standard deviation.

Clause 13. The computer-readable storage medium of clause 12, wherein determining the at least one scaling factor comprises identifying a quantity of bits available for quantization.

Clause 14. The computer-readable storage medium of clause 10, wherein the method further comprises: translating the set of vectors prior to determining the at least one scaling factor by subtracting a centroid of the dataset from each vector in the set of vectors.

Clause 15. The computer-readable storage medium of clause 10, wherein the at least one scaling factor comprises a first scaling factor and a second scaling factor, and wherein the method further comprises: separating the vector into at least a first channel and a second channel prior to determining the at least one scaling factor, wherein the first channel and the second channel each comprise one or more dimensions of the plurality of dimensions, wherein the first scaling factor corresponds to the first channel, and wherein the second scaling factor corresponds to the second channel.

Clause 16. The computer-readable storage medium of clause 15, wherein the method further comprises: causing an update to an order of the plurality of dimensions in the vector to group dimensions with similar component values together prior to separating the vector into at least the first channel and the second channel.

Clause 17. The computer-readable storage medium of clause 10, wherein the method further comprises: subtracting a centroid of the dataset from the vector prior to determining the at least one scaling factor; determining an additional value for the vector, wherein the additional value comprises a dot product of the centroid and the vector; and storing the additional value with the quantized vector.

Clause 18. A computing system comprising: at least one processor; a computer-readable storage medium operatively coupled to the at least one processor; and program instructions stored on the computer-readable storage medium that, when executed by the at least one processor, direct the computing system to perform a method, the method comprising: receiving a set of vectors from a dataset, wherein each vector in the set of vectors comprises a plurality of dimensions; and for a vector in the set of vectors: determining at least one scaling factor for the plurality of dimensions; adjusting the at least one scaling factor for the plurality of dimensions based on a quantization error to generate at least one adjusted scaling factor for the plurality of dimensions; and determining a quantized vector based on the at least one adjusted scaling factor for the plurality of dimensions.

Clause 19. The computing system of clause 18, wherein determining the at least one scaling factor comprises determining an initial lower endpoint and an initial upper endpoint based on a mean and a standard deviation.

Clause 20. The computing system of clause 18, wherein the method further comprises: subtracting a centroid of the dataset from the vector prior to determining the at least one scaling factor; determining an additional value for the vector, wherein the additional value comprises a dot product of the centroid and the vector; and storing the additional value with the quantized vector.

In accordance with aspects of the disclosure, implementations of various techniques and methods described herein may be implemented in digital electronic circuitry, or in computer hardware, firmware, software, or in combinations of them. Implementations may be implemented as a computer program product (e.g., a computer program tangibly embodied in an information carrier, a machine-readable storage device, a computer-readable medium, a tangible computer-readable medium), for processing by, or to control the operation of, data processing apparatus (e.g., a programmable processor, a computer, or multiple computers). In some implementations, a tangible computer-readable storage medium may be configured to store instructions that, when executed, cause a processor to perform a process. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or on multiple computers at one site or distributed across multiple sites and interconnected by a communication network.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the implementations. They have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

It will be understood that, in the foregoing description, when an element is referred to as being on, connected to, electrically connected to, coupled to, or electrically coupled to another element, it may be directly on, connected or coupled to the other element, or one or more intervening elements may be present. In contrast, when an element is referred to as being directly on, directly connected to or directly coupled to another element, there are no intervening elements present. Although the terms directly on, directly connected to, or directly coupled to may not be used throughout the detailed description, elements that are shown as being directly on, directly connected or directly coupled can be referred to as such. The claims of the application, if any, may be amended to recite exemplary relationships described in the specification or shown in the figures.

As used in this specification, a singular form may, unless definitively indicating a particular case in terms of the context, include a plural form. Spatially relative terms (e.g., over, above, upper, under, beneath, below, lower, and so forth) are intended to encompass different orientations of the device in use or operation in addition to the orientation depicted in the figures. In some implementations, the relative terms above and below can, respectively, include vertically above and vertically below. In some implementations, the term adjacent can include laterally adjacent to or horizontally adjacent to.

What is claimed is:

1. A method comprising:
receiving a set of vectors from a dataset, wherein each vector in the set of vectors comprises a plurality of dimensions; and
for a vector in the set of vectors:
determining at least one scaling factor for the plurality of dimensions;
adjusting the at least one scaling factor for the plurality of dimensions based on a quantization error to generate at least one adjusted scaling factor for the plurality of dimensions; and
determining a quantized vector based on the at least one adjusted scaling factor for the plurality of dimensions.

2. The method of claim 1, wherein the plurality of dimensions comprises a plurality of normalized dimensions.

3. The method of claim 1, wherein determining the at least one scaling factor comprises determining an initial lower endpoint and an initial upper endpoint based on a mean and a standard deviation.

4. The method of claim 3, wherein determining the at least one scaling factor comprises identifying a quantity of bits available for quantization.

5. The method of claim 1, further comprising translating the set of vectors prior to determining the at least one scaling factor by subtracting a centroid of the dataset from each vector in the set of vectors.

6. The method of claim 1, wherein the at least one scaling factor comprises a first scaling factor and a second scaling factor, and wherein the method further comprises:
separating the vector into at least a first channel and a second channel prior to determining the at least one scaling factor, wherein the first channel and the second channel each comprise one or more dimensions of the plurality of dimensions, wherein the first scaling factor corresponds to the first channel, and wherein the second scaling factor corresponds to the second channel.

7. The method of claim 6, further comprising:
causing an update to an order of the plurality of dimensions in the vector to group dimensions with similar component values together prior to separating the vector into at least the first channel and the second channel.

8. The method of claim 1, further comprising:
subtracting a centroid of the dataset from the vector prior to determining the at least one scaling factor;
determining an additional value for the vector, wherein the additional value comprises a dot product of the centroid and the vector; and
storing the additional value with the quantized vector.

9. The method of claim 1, further comprising:
for a second vector in the set of vectors:
determining at least one additional scaling factor for the plurality of dimensions associated with the second vector;
adjusting the at least one additional scaling factor for the plurality of dimensions associated with the second vector based on a second quantization error to generate at least one additional adjusted scaling factor for the plurality of dimensions, wherein the at least one additional adjusted scaling factor is different than the at least one scaling factor; and
determining a second quantized vector based on the at least one additional adjusted scaling factor for the plurality of dimensions associated with the second vector.

10. A computer-readable storage medium having program instructions stored thereon that, when executed by at least one processor, direct the at least one processor to perform a method, the method comprising:
receiving a set of vectors from a dataset, wherein each vector in the set of vectors comprises a plurality of dimensions; and
for a vector in the set of vectors:
determining at least one scaling factor for the plurality of dimensions;
adjusting the at least one scaling factor for the plurality of dimensions based on a quantization error to generate at least one adjusted scaling factor for the plurality of dimensions; and
determining a quantized vector based on the at least one adjusted scaling factor for the plurality of dimensions.

11. The computer-readable storage medium of claim 10, wherein the plurality of dimensions comprises a plurality of normalized dimensions.

12. The computer-readable storage medium of claim 10, wherein determining the at least one scaling factor comprises determining an initial lower endpoint and an initial upper endpoint based on a mean and a standard deviation.

13. The computer-readable storage medium of claim 12, wherein determining the at least one scaling factor comprises identifying a quantity of bits available for quantization.

14. The computer-readable storage medium of claim 10, wherein the method further comprises:
translating the set of vectors prior to determining the at least one scaling factor by subtracting a centroid of the dataset from each vector in the set of vectors.

15. The computer-readable storage medium of claim 10, wherein the at least one scaling factor comprises a first scaling factor and a second scaling factor, and wherein the method further comprises:
separating the vector into at least a first channel and a second channel prior to determining the at least one scaling factor, wherein the first channel and the second channel each comprise one or more dimensions of the plurality of dimensions, wherein the first scaling factor corresponds to the first channel, and wherein the second scaling factor corresponds to the second channel.

16. The computer-readable storage medium of claim 15, wherein the method further comprises:
causing an update to an order of the plurality of dimensions in the vector to group dimensions with similar component values together prior to separating the vector into at least the first channel and the second channel.

17. The computer-readable storage medium of claim 10, wherein the method further comprises:
subtracting a centroid of the dataset from the vector prior to determining the at least one scaling factor;
determining an additional value for the vector, wherein the additional value comprises a dot product of the centroid and the vector; and
storing the additional value with the quantized vector.

18. A computing system comprising:
at least one processor;
a computer-readable storage medium operatively coupled to the at least one processor; and
program instructions stored on the computer-readable storage medium that, when executed by the at least one processor, direct the computing system to perform a method, the method comprising:
receiving a set of vectors from a dataset, wherein each vector in the set of vectors comprises a plurality of dimensions; and
for a vector in the set of vectors:
determining at least one scaling factor for the plurality of dimensions;
adjusting the at least one scaling factor for the plurality of dimensions based on a quantization error to generate at least one adjusted scaling factor for the plurality of dimensions; and
determining a quantized vector based on the at least one adjusted scaling factor for the plurality of dimensions.

19. The computing system of claim 18, wherein determining the at least one scaling factor comprises determining an initial lower endpoint and an initial upper endpoint based on a mean and a standard deviation.

20. The computing system of claim 18, wherein the method further comprises:
subtracting a centroid of the dataset from the vector prior to determining the at least one scaling factor;
determining an additional value for the vector, wherein the additional value comprises a dot product of the centroid and the vector; and
storing the additional value with the quantized vector.
